(19) United States
(12) Patent Application Publication
(10) Pub. No.: US 2010/0241490 A1
(43) Pub. Date: Sep. 23, 2010

(54) EVALUATING EXTENDED SUPPLY CHAINS

(76) Inventors: William John Purcell, Alamo, CA (US); Wayne Howard Levy, Deerfield, IL (US)

Correspondence Address: CAVEN & AGHEVLI LLC, 9249 S. BROADWAY BLVD, UNIT 200-201, HIGHLANDS RANCH, CO, 80129, US

(21) Appl. No.: 12/728,102

(22) Filed: Mar. 19, 2010

Related U.S. Application Data
(60) Provisional application No. 61/161,755, filed on Mar. 19, 2009.

(51) Int. Cl. G06Q 10/00; G06Q 50/00

(52) U.S. Cl. 705/10; 705/28

(57) ABSTRACT

Techniques described herein generally relate to evaluating extended supply chains. In an embodiment, supply chains may be evaluated by efficiently linking current, past, and/or upcoming consumer demand signals to the supply chain. The evaluated supply chains may be extended supply chains, e.g., at select points along supply chains. Other embodiments are disclosed and claimed.

### RELATED APPLICATION

The present patent application is related to and claims priority from U.S. Provisional Patent Application No. 61/161,755, filed Mar. 19, 2009, entitled “Evaluating Extended Supply Chains”, which is incorporated herein by reference for all purposes.

### FIELD

The subject matter described herein generally relates to supply chain management. In some embodiments, techniques described herein may be used to evaluate extended supply chains, e.g., at select points along a supply chain.

### BACKGROUND

One major goal of any retailer or manufacturer is to avoid or at least reduce Out-of-Stock situations (also referred to as “Out-of-Stocks”). If a product is out-of-stock, a potential purchaser may decide to buy a different product, buy the product from a different source, or forego the purchase altogether.

In case of Consumer Packaged Goods (CPG) manufacturers and retailers, efficient shelf management can be of great importance also. For example, if valuable shelf space is left empty or a back room is out of space, a retailer will lose sales and goodwill of its customers.

Moreover, in recent years, retailers and their suppliers have invested millions of dollars to update supply chain systems to enable them to better compete. At the same time, these same retailers are expected to carry an increasing number of products, without a corresponding increase in the shelf space to sell them in, creating a significantly more complex process for tuning inventory to consumer demand. The problems even become more pronounced in case of perishable fresh produce or raw material.

Hence, balancing inventory throughout the supply chain is an important problem to solve for retailers, suppliers, and manufacturers alike.

### BRIEF DESCRIPTION OF THE DRAWINGS

The accompanying drawings are included to provide further understanding of some embodiments of the invention, illustrate some of the various embodiments of the invention, and together with the description serve to explain the principles and operations of some embodiments of the invention.

FIGS. 1-3 illustrate block diagrams of various systems according to some embodiments.

FIG. 4 illustrates a block diagram of a computer system 400 that may be utilized in various embodiments of the invention.

### DETAILED DESCRIPTION

In the following description, numerous specific details are set forth in order to provide a thorough understanding of embodiments of the invention. Embodiments of the invention may be practiced without some or all of these specific details. In other instances, well known process operations have not been described in detail in order not to unnecessarily obscure embodiments of the invention.

Also, reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

As discussed above, in case of CPG manufacturers and retailers, efficient shelf management can be of great importance. For example, if valuable shelf space is left empty or a back room is out of space, a retailer will lose sales and goodwill of its customers. Accordingly, the future success of fast-moving CPG manufacturers and retailers depends on efficiently linking current, past, and/or upcoming consumer demand signals to the supply chain.

To this end, some embodiments discussed herein may be used to evaluate supply chains, for example, by efficiently linking current, past, and/or upcoming consumer demand signals to the supply chain. In one instance, the upcoming consumer demand may be determined based on current and/or past consumer demand at a select time and/or point of the supply chain. The evaluated supply chains may be extended supply chains, e.g., at select points along supply chains. For example, the points along a supply chain may extend from the source of raw material (such as a farm) through various manufacturer(s), distributor(s), and/or retailer distribution center(s) and through various forms of retail distribution (such as retail stores, direct-to-consumer marketing, on-line commerce, etc.) and even into the consumer's pantry or refrigerator. In one embodiment, information at a consumer's pantry (or refrigerator) may be collected for evaluation through wireless techniques (e.g., via Radio Frequency (RF) tags attached to each item or group of items) and/or optical techniques (e.g., by scanning barcode labels present on each item or group of items).

In an embodiment, it may be determined how well an extended supply chain is operating. For example, at each spot along the way a measurement (or index calculation) may be made in terms of how inventory will likely match upcoming consumer demand when an item is needed in the store. The time perspective may vary according to the location of the inventory. For instance, inventory that is in the store today might be needed to match demand today, inventory on order for a distribution center might not need to match demand for a week.

In some embodiments, at each spot along the chain, users (or an automated computer-based algorithm) may make decisions. For example, perhaps the “perfect order” for stores next week means that they will need 100 cases to be shipped to the retailer DC (Distribution Center) in a week. But, the product comes 96 to a case. They cut the order by 4, and we may measure the impact of this change relative to the actual consumer need by an index. Furthermore, the level of “match” (throughout the supply chain overall or at any point along the way) may be measured as an index.

In an embodiment, the extended supply chain may include various entities such as one or more of: store shelf, back room, inbound order to store, retailer distribution center, inbound orders to a DC, CPG distribution center, CPG DC, further up the CPG supply chain, etc.

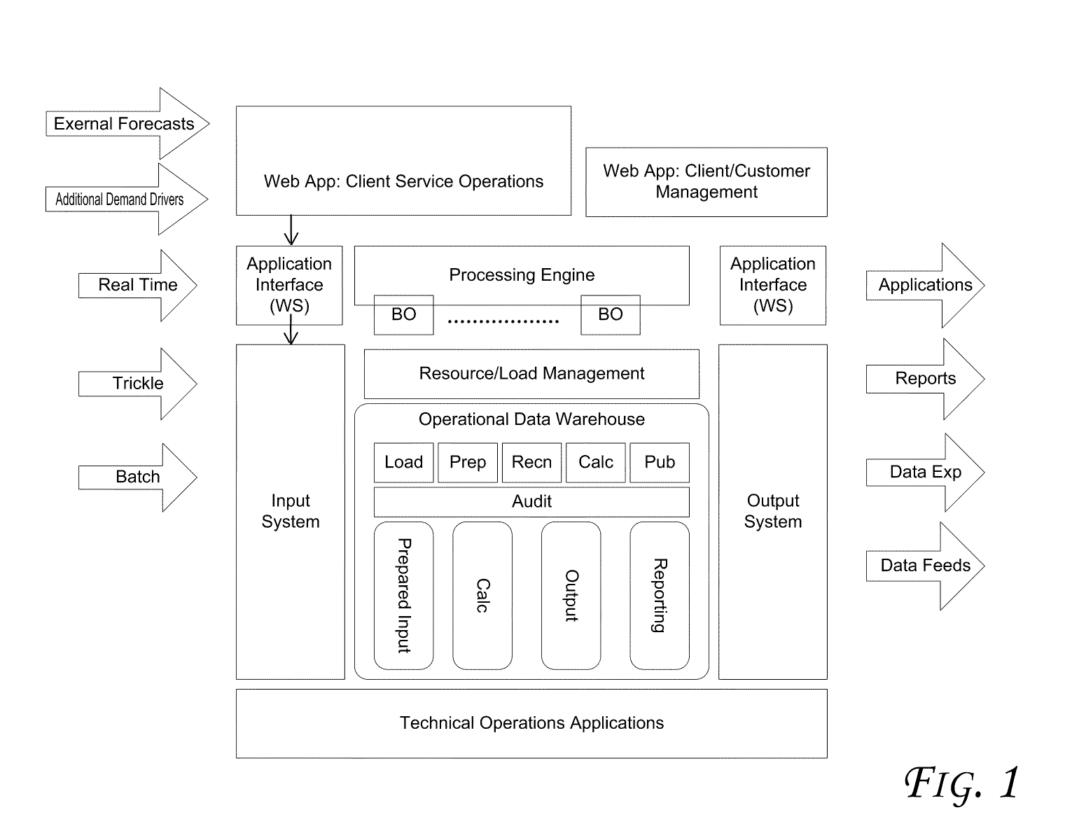

Various systems such as one or more of those discussed herein with reference to FIGS. 1-4 may be utilized to implement various embodiments.

More particularly, FIG. 1 illustrates a top level system in accordance with an embodiment. As shown in FIG. 1, the system may receive input data such as real time, trickle, or batch input data (which may include data input from retailers and suppliers). The input data may be received through an input system which may be designed to handle POS (Point Of Sale), inventory, shipment, “Demand Driver data” (factors which influence sales, such as past, current, and future promotion, pricing, advertising, weather, local events, issuance of government benefits such as food stamps, and/or a number of additional factors (Demand Drivers 7-999,999,999), Externally Generated Forecasts and Externally Generated Coefficients and other relevant data streams. As discussed above, wireless and/or optical techniques may be used to collect the input data at the various points in the supply chains.

Externally Generated Forecasts may include forecasts that have been created outside of the core system. One embodiment of this is when a participant in the extended supply chain of a retailer such as a supplier provides a forecast based upon the retailers data but created in the suppliers system. Externally Generated Coefficients may include statistics created outside of the core system and then used in the core system to adjust consumer demand forecasts. One embodiment of this is when a participant in the extended supply chain of a retailer such as a supplier provides a coefficient based upon the retailers data but created in the suppliers system.

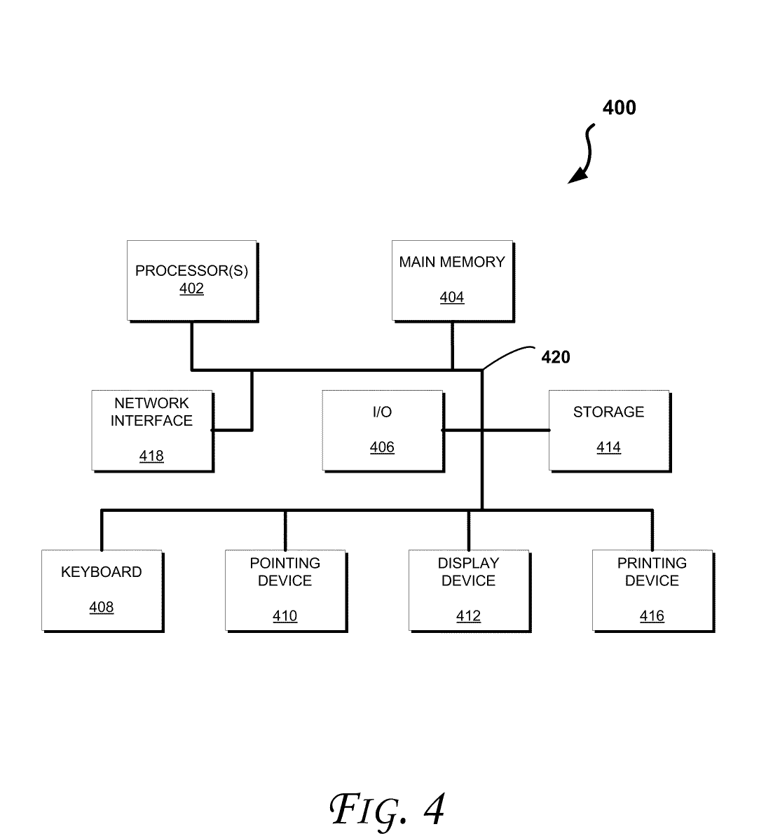

As shown in FIG. 1, one or more application interfaces (such as Web Services (WSs)) may be used as an interface to operate various functions provided by the system. Also, one or more web applications (e.g., to manage client service operations and/or to provide client/customer management) may be included in the system. A processing engine may be coupled to one or more Back Office (BO) resources to manage BO inventory, information, etc. A resource/load management module may be coupled to an operational Data Warehouse (DW). The operational DW may provide load, preparation, reconciliation, calculation, and/or publication facilities. An audit module may audit operations/data at any point in the system of FIG. 1 (such as auditing of prepared input, calculation, output, and/or reporting). An output system may provide data to applications, for reports, data exporting, and/or data feeds. Also, technical operations applications may be provided in the system to control technical operations of various modules of the system. Even though some of the items discussed herein refer to a web-based application/implementation, all embodiments are not necessarily required to utilize web-based services. For example, a stand-alone (or non-networked) computing system may be used. Also, various embodiments may utilize different types of networks (such as intranet, wide-area networks, cellular network, wireless broadband, or other networks discussed herein (see, FIG. 4, for example), etc.) and not limited to an Internet-based network. Furthermore, a combination of network technologies may be used in some embodiments.

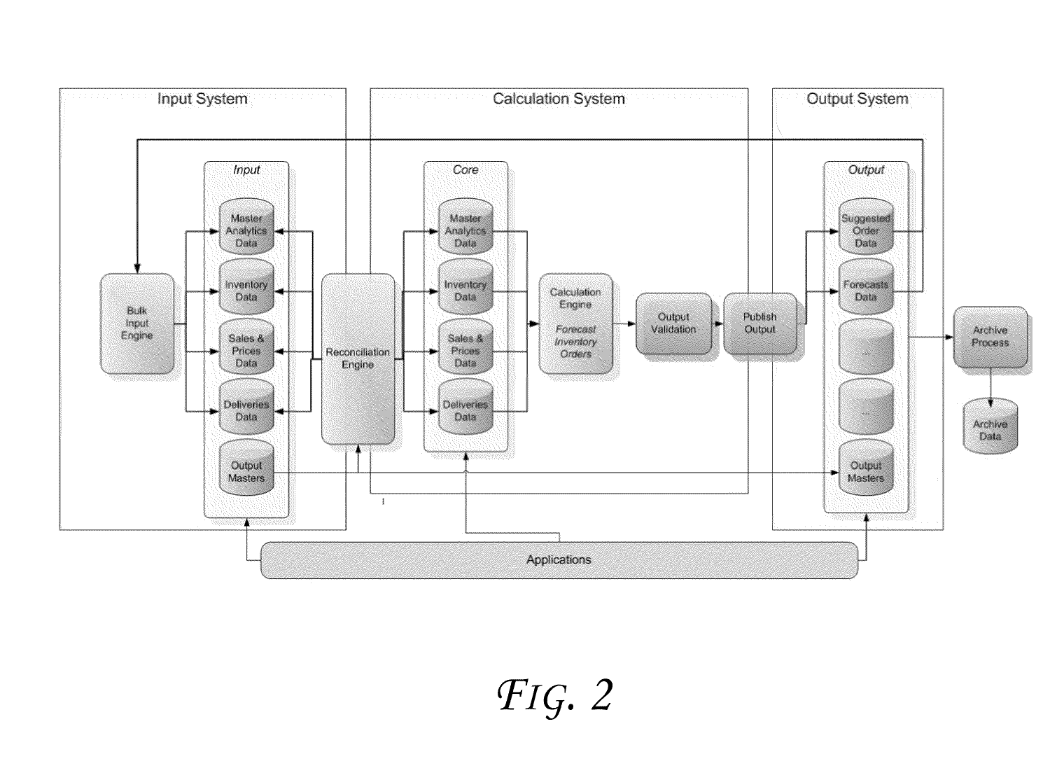

FIG. 2 illustrates a block diagram of a system according to an embodiment. As with the system of FIG. 1, the system of FIG. 2 also includes an input system and an output system. A calculation system is also provided that couples the input system to the output system. Different types of input data may be received such as discussed with reference to FIG. 1 but as an example a bulk input engine may receive input data. Various input data may be provided such as master analytics data, inventory data, sales and prices data, deliveries data, and/or output masters in the input system. Also, input tables may be provided such as sales and price table (e.g., including forecasts), delivery table, shipment table, and/or orders (e.g., including suggested orders, orders from handhelds, orders from customers), and/or inventory (which may be populated from handheld, mobile apps, bulk load, and/or order guide).

Referring to FIG. 2, a reconciliation engine may be coupled to the input data bases and core data bases (e.g., provided in the calculation system). As shown, the core data may include master analytics data, inventory data, sales and prices data, and/or deliveries data. In an embodiment, the reconciliation engine may reconcile the input data in accordance with the output masters (in the input data and/or output data such as shown in FIG. 2) to provide the core data for the calculation system. Also, core tables may be provided for inventory, sales and price, deliveries, and/or master data (calculating a measurement/index). Further, master analytics data may include turn parameters, data adjustments, promotion model, merchandise model, inventor model, and/or store item active data.

The core data is provided to a calculation engine (which may forecast inventory orders). The calculation output may then be validated and published to the output system. The output data within the output system may include suggested order data, forecasts data, inventory, targets, calculated minimums, output masters, etc. (e.g., such as the data discussed with reference to FIG. 1).

Output of the output system may be archived via an archive process in an archive data storage. Further, as shown in FIG. 2, one or more applications may have access to the input, core, and output data, e.g., for data management, technical operation management of modules within the system of FIG. 2, etc. For example, the applications may submit data to input and output systems. Applications may be distributed (or disconnected) versions of the core and calculation engines in some embodiments. Additionally, system control may be performed via one or more process queues, and DC administration module, through a project management module, etc. Security (e.g., via encryption) and data logging may also be provided in some embodiments.

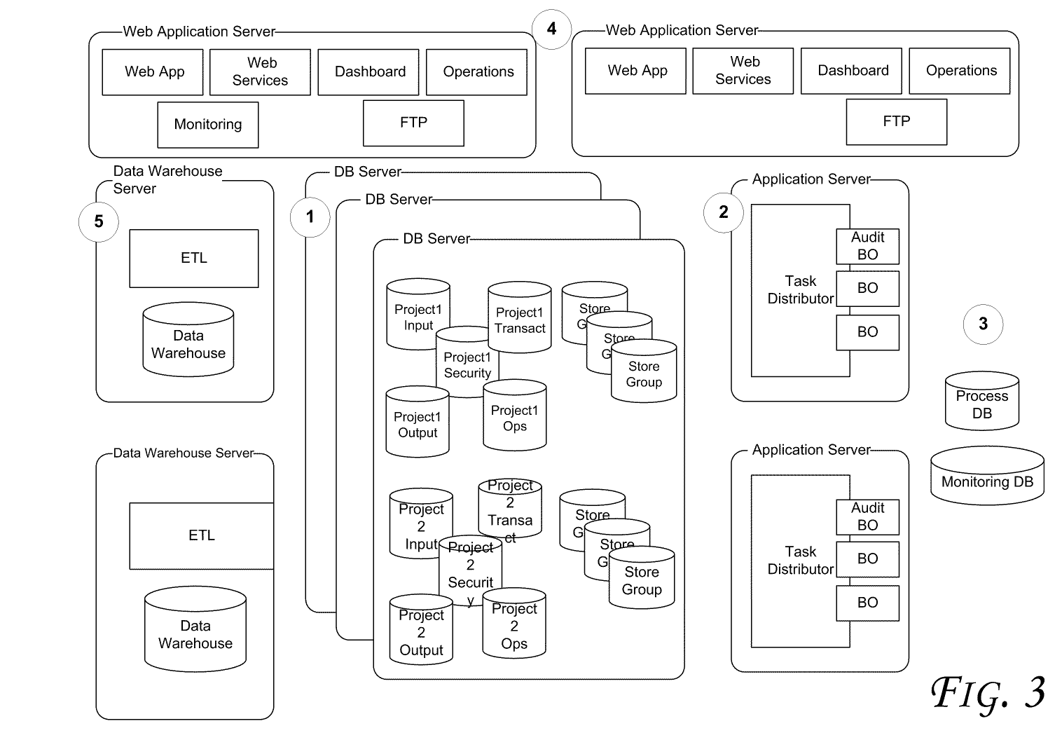

FIG. 3 illustrates a block diagram of a system in accordance with one embodiment. Various items in the system of FIG. 3 are marked with numerals 1 through 5. The following is a logical breakout of the server types and components of FIG. 3. Although many servers are shown, these may be consolidated in smaller systems or distributed in larger, co-located, or remote systems.

1—DB Servers would contain one or more project database sets (or projects spread across DB servers). The server could be a DW appliance such as those provided by Netezza™ Corporation as well. In some embodiments, these could be OS and/or DB agnostic.

2—Application servers contain the task distributor and associated dependencies. These may perform light weight jobs—e.g., pushing all processing burden to the DB servers. However, multiple instances may be run on a single server (or on multiple servers) using the same task queue DB. In some embodiment, a Windows® server may be used for the server(s).

3—These are central DB's. Location could be anywhere, so they are not shown tied to any specific server.

4—All web-based applications. Possible to have multiple to load balance. Acts as the application interface for many operations.

5—ETL (Extract, Transform, Load) modules and DW.

Accordingly, in some embodiments, input data originating from one or more sources along a supply chain are received (e.g., and stored in a memory, such as those discussed with reference to FIG. 4). Based on the input data (e.g., corresponding to current or past consumer demand) at least one index may be calculated (e.g., by a processor and based on one or more instructions, see, for example FIG. 4). The index may be indicative of how inventory will likely match upcoming consumer demand at a select time and at a select point of the supply chain. The index may be indicative of how the inventory is matched to current consumer demand. The selected point in time may be a next order cycle (or any order cycle after a next order cycle) for a product shipment to a store or a distribution center.

In an embodiment, the selected point in time is a next order cycle (or any order cycle after a next order cycle) for a product shipment to a distribution center or a store. The calculated index may be compared to an index (e.g., by a processor and based on stored data) that would be generated if the product (or a different product) was distributed/shipped to the same store (or a different store) from the same or an different distribution center, distributed/shipped to the distribution center (or a different distribution center), at a different time period for the store or the distribution center, and/or any combinations thereof. The comparison may provide evaluation of supply chains at various points/times such as discussed herein. For example, the calculated index and/or the comparison results may be used to determine future orders and inventory management more efficiently.

FIG. 4 illustrates a block diagram of computer system 400 that may be utilized in various embodiments of the invention. In an embodiment, the system 400 may be utilized to perform operations and/or to provide storage for the various data discussed with reference to FIGS. 1-3. The system 400 may include one or more processors 402, a main memory 404, an input/output (I/O) controller 406, a keyboard 408, a pointing device 410 (e.g., mouse, track ball, pen device, or the like), a display device 412, a mass storage 414 (e.g., a nonvolatile storage such as a hard disk, an optical drive, or the like), and a network interface 418. Additional input/output devices, such as a printing device 416, may be included in the system 400 as desired. As illustrated in FIG. 4, the various components of the system 400 may communicate through a system bus 420 or similar architecture. More than one bus (or interconnect) may be used for the communication between various elements.

In accordance with an embodiment of the invention, the processor 402 may be a complex instruction set computer (CISC) microprocessor, a reduced instruction set computing (RISC) microprocessor, a very long instruction word (VLIW) microprocessor, a processor implementing a combination of instruction sets, or the like.

Moreover, the network interface 418 may provide communication capability with other computer systems on a same local network, on a different network connected via modems or the like to the present network, or to other computers across the Internet. In various embodiments of the invention, the network interface 418 may be implemented by utilizing technologies including, but not limited to, Ethernet, Fast Ethernet, Gigabit Ethernet, wide-area network (WAN), leased line (such as T1, T3, optical carrier 4 (OC3), or the like), analog modem, digital subscriber line (DSL and its varieties such as high bit-rate DSL (HDSL), integrated services digital network DSL (IDSL), or the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 400 may utilize operating systems such as Solaris, Windows (and its varieties such as CE, NT, 2000, XP, ME, Vista, or the like), HP-UX, IBM-AIX, PALM, UNIX, Berkeley software distribution (BSD) UNIX, Linux, Apple UNIX (AUX), Macintosh operating system (Mac OS) (including Mac OS X), or the like. Also, in certain embodiments of the invention, the computer system 400 may be a general purpose computer capable of running any number of applications.

In various embodiments of the invention, the operations discussed herein, e.g., with reference to FIGS. 1-4, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any suitable storage device such as those discussed with respect to FIG. 1-4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

In the description and claims, the terms “coupled” and “connected,” along with their derivatives, may be used. In some embodiments of the invention, “connected” may be used to indicate that two or more elements are in direct physical contact with each other. “Coupled” may mean that two or more elements are in direct physical contact. However, “coupled” may also mean that two or more elements may not be in direct contact with each other, but may still cooperate or interact with each other.

Although embodiments have been described in language specific to structural features and/or methodological acts, it is to be understood that claimed subject matter may not be limited to the specific features or acts described. Rather, the specific features and acts are disclosed as sample forms of implementing various embodiments. While the invention has been described above in conjunction with one or more specific embodiments, it should be understood that the invention is not intended to be limited to one embodiment. The invention is intended to cover alternatives, modifications, and equivalents as may be included within the spirit and scope of the invention, such as those defined by the appended claims.

1. A method comprising:
receiving input data originating from one or more sources along a supply chain; and
calculating at least one index that is indicative of how inventory will likely match upcoming consumer demand at a select time and at a select point of the supply chain, at least in part, based on the input data corresponding to current or past consumer demand.

2. The method of claim 1, wherein the index is to be indicative of how the inventory is matched to current consumer demand.

3. The method of claim 1, wherein the selected point in time is a next order cycle for a product shipment to a store or a distribution center.

4. The method of claim 1, wherein the selected point in time is a next order cycle for a product shipment to a distribution center, the method further comprising comparing the calculated index to an index that would be generated if the product was distributed to a same store from an different distribution center.

5. The method of claim 1, wherein the selected point in time is any order cycle after a next order cycle for a product shipment to a store or a distribution center.

6. The method of claim 1, wherein the selected point in time is any order cycle after a next order cycle for a product shipment to a store, the method further comprising comparing the calculated index to an index that would be generated if the product was shipped to a same store from an different distribution center.

7. The method of claim 1, wherein the selected point in time is any order cycle after a next order cycle for a product shipment to a store from a distribution center, the method further comprising comparing the calculated index to an index that would be generated if the product was shipped to a same store at a different time period for the store or the distribution center.

8. The method of claim 1, wherein the selected point in time is any order cycle after a next order cycle for a product shipment to a store from a distribution center, the method further comprising comparing the calculated index to an index that would be generated for a different product at a different time period for the store or the distribution center.

9. The method of claim 1, wherein the selected point in time is any order cycle after a next order cycle for a product shipment to a store from a distribution center, the method further comprising comparing the calculated index to an index that would be generated for the product at a different time period for a different store or a different distribution center.

10. A system comprising:
a memory to store input data received from one or more sources along a supply chain; and
a processor coupled to the memory to determine at least one index that is indicative of how inventory will likely match upcoming consumer demand at a select time and at a select point of the supply chain, at least in part, based on the input data corresponding to current or past consumer demand.

11. The system of claim 10, wherein the index is to be indicative of how the inventory is matched to current consumer demand.

12. The system of claim 10, wherein the selected point in time is a next order cycle for a product shipment to a store or a distribution center.

13. The system of claim 10, wherein the selected point in time is a next order cycle for a product shipment to a distribution center or a store, the method further comprising comparing the calculated index to an index that would be generated if the product or a different product was shipped to a same store from an different distribution center or to a different store from the distribution center or a different distribution center.

14. The system of claim 10, wherein the selected point in time is any order cycle after a next order cycle for a product shipment to a store or a distribution center.

15. The system of claim 10, wherein the selected point in time is any order cycle after a next order cycle for a product shipment to a store or a distribution center, the method further comprising comparing the calculated index to an index that would be generated if the product or a different product was shipped to a same store from an different distribution center or to the same store at a different time period for the store or the distribution center.

16. A computer-readable storage device to store one or more instructions, wherein the one or more instructions when executed by a process are to cause the processor to:
receive input data originating from one or more sources along a supply chain; and
calculate at least one index that is indicative of how inventory will likely match upcoming consumer demand at a select time and at a select point of the supply chain, at least in part, based on the input data corresponding to current or past consumer demand.

17. The storage device of claim 16, wherein the index is to be indicative of how the inventory is matched to current consumer demand.

18. The storage device of claim 16, wherein the selected point in time is a next order cycle for a product shipment to a store or a distribution center.

19. The storage device of claim 16, wherein the selected point in time is a next order cycle for a product shipment to a distribution center or a store, the method further comprising comparing the calculated index to an index that would be generated if the product or a different product was shipped to a same store from an different distribution center or to a different store from the distribution center or a different distribution center.

20. The system of claim 10, wherein the selected point in time is any order cycle after a next order cycle for a product shipment to a store or a distribution center, the method further comprising comparing the calculated index to an index that would be generated if the product or a different product was shipped to a same store of a different store from the distribution center or a different distribution center at a different time period for the store or the distribution center.
